(19) United States
(12) Patent Application Publication
(10) Pub. No.: US 2017/0110783 A1
(43) Pub. Date: Apr. 20, 2017

(54) CHIP ANTENNA

(71) Applicants: Tomokazu SONOZAKI, Mie (JP); Hiroyuki NODA, Mie (JP); Natsuhiko MORI, Mie (JP); NTN CORPORATION, Osaka (JP)

(72) Inventors: Tomokazu SONOZAKI, Mie (JP); Hiroyuki NODA, Mie (JP); Natsuhiko MORI, Mie (JP)

(21) Appl. No.: 15/127,241

(22) PCT Filed: Mar. 6, 2015
(86) PCT No.: PCT/JP2015/056602

§ 371 Date: Sep. 19, 2016

(30) Foreign Application Priority Data
Mar. 20, 2014 (JP) 2014-058022

(51) Int. Cl. H01Q 1/22; H01Q 9/42; H01Q 1/38

(52) U.S. Cl. CPC H01Q 1/2283; H01Q 1/2291; H01Q 1/38; H01Q 9/42

(57) ABSTRACT

Provided is a chip antenna (1), including: an antenna pattern (3) formed through bending a conductive plate into a three-dimensional shape, the antenna pattern including an antenna part (31) and a terminal part (32) electrically connected to a circuit substrate (10); and a base body (2) formed through injection molding a resin with the antenna pattern (3) serving as an insert component, in which the base body (2) includes: a rectangular plate-like top wall (21) holding the antenna part (31) on a surface thereof; and a rectangular plate-like vertical wall (22) provided upright along a long-side direction of the top wall (21) with one end (upper end) thereof in a short-side direction being connected to the top wall (21) and with another end (lower end) thereof in the short-side direction holding the terminal part (32).

### TECHNICAL FIELD

The present invention relates to a chip antenna that is incorporated into wireless communication devices having the function of wireless communication such as a mobile telephone (including a smartphone), a tablet PC, and a smart meter (digital wattmeter).

### BACKGROUND ART

Portable wireless communication devices such as a smartphone and a tablet PC that are rapidly becoming widespread in recent years are becoming even smaller and even thinner. As an antenna incorporated into this kind of wireless communication device, a chip-like antenna (chip antenna) mountable on a surface of a circuit substrate is suitably used.

An exemplary chip antenna is disclosed in Patent Literature 1 described below. The chip antenna includes a chip-like base body made of a high-permittivity resin and an antenna pattern of a conductor formed on a surface of the base body. The chip antenna can be manufactured through, for example, a step of forming a conductor film on the surface of the base body made of resin, a step of forming, on the conductor film, a mask pattern corresponding to the shape of the antenna pattern, a step of removing, after removing a region of the conductor film that is not covered with the mask pattern through etching, the mask pattern to form the desired antenna pattern on the base body.

In recent years, for the purpose of further downsizing the chip antenna, forming the antenna pattern along a plurality of surfaces of the base body (forming the antenna pattern into a three-dimensional shape) has been considered. However, the technology disclosed in Patent Literature 1 is, due to the necessity of a plurality of laborious steps, not only difficult in view of the cost but also has a problem that it is difficult to form the antenna pattern in the three-dimensional shape with accuracy. Accordingly, the applicant of the present invention proposes a chip antenna including an antenna pattern formed through bending a conductive plate into a three-dimensional shape, and a base body formed through injection molding a resin with the antenna pattern in the three-dimensional shape serving as an insert component (see Patent Literature 2).

Incidentally, in order for a chip antenna having an antenna pattern in a three-dimensional shape to exhibit antenna characteristics with stability, it is necessary to especially hold a part of the antenna pattern that functions as an antenna part configured to transmit/receive radio waves on a surface of a base body. However, in an antenna pattern formed through bending a conductive plate into a three-dimensional shape, for example, an angle formed by a bent part may increase due to elastic force of the bent part, and as a result, the antenna pattern may be partly separated from the base body. Accordingly, in the chip antenna of Patent Literature 2, the antenna pattern is held on the surface of the base body through taking measures such as forming, at an edge of the antenna pattern, a protruding part to be embedded in the base body, or increasing a surface roughness of the antenna pattern at least at a joining surface with the base body.

### CITATION LIST

Patent Literature 1: JP 2005-80229 A

Patent Literature 2: JP 2012-74835 A

### SUMMARY OF INVENTION

### Technical Problem

However, when, as in the chip antenna of Patent Literature 2, a base body made of a resin is formed into the shape of a thick rectangular parallelepiped, relatively large warpage or sink marks (recesses) occur in the base body as mold shrinkage proceeds. In particular, in application of transmitting/receiving radio waves in a low frequency band, it is necessary to increase an antenna size (increase a length of the chip antenna) for wavelength reasons, and thus, the amount of warpage of the base body (the amount of warpage of the base body along a long-side direction thereof) accompanying the mold shrinkage is liable to increase. Therefore, even when the measures described above are taken, an antenna pattern is liable to partly float up from a surface of the base body, and desired antenna characteristics are less likely exhibited.

From the viewpoint of reducing the amount of sink marks (recesses) accompanying the mold shrinkage, it is also conceivable that the base body in the shape of a rectangular parallelepiped may be thinned. However, simply thinning the base body lowers the rigidity of the base body to a large extent, and thus the base body may be deformed to a large extent as the temperature changes, for example. In this case, it becomes more difficult to hold the antenna pattern on the surface.

In view of the situation described above, it is an object of the present invention to provide a chip antenna at low cost that can prevent, to the largest extent possible, deformation of the base body accompanying mold shrinkage and temperature change and thus can exhibit desired antenna characteristics with stability.

### Solution to Problem

According to one embodiment of the present invention, which has been devised to achieve the above-mentioned object, there is provided a chip antenna, comprising: an antenna pattern formed through bending a conductive plate into a three-dimensional shape, the antenna pattern comprising an antenna part and a terminal part electrically connected to a circuit substrate; and a base body formed through injection molding a resin with the antenna pattern serving as an insert component, wherein the base body comprises: a rectangular plate-like top wall holding the antenna part on a surface thereof, and a rectangular plate-like vertical wall provided upright along a long-side direction of the top wall with one end thereof in a short-side direction being connected to the top wall and with another end thereof in the short-side direction holding the terminal part. The antenna part is a part configured to perform at least one of transmission and reception of radio waves.

When the base body comprises the rectangular plate-like top wall and the rectangular plate-like vertical wall provided upright along the long-side direction of the top wall with the one end thereof in the short-side direction being connected to the top wall in this way, not only are the respective parts of the base body able to be thinned (into a thin plate) to reduce the amount of sink marks (recesses) that occur accompanying mold shrinkage, but also the rigidity (flexural rigidity) of the top wall can be enhanced to prevent warpage, a crook, or the like of the base body in a direction along the long-side direction of the top wall to the largest extent possible. Therefore, the antenna part of the antenna pattern can be held on the surface of the base body (top wall) with stability, and desired antenna characteristics can be exhibited. Further, according to the structure described above, the amount of usage of the resin can be reduced to reduce the cost.

The base body may be in an arbitrary shape insofar as the base body can be injection molded with the antenna pattern in the three-dimensional shape serving as the insert component, and, for example, the vertical wall may be formed along each of two long sides of the top wall. In this case, the base body (chip antenna) exhibits a concave shape (reverse concave shape) in arbitrary section in a direction orthogonal to the long-side direction, and thus, the rigidity of the chip antenna can be effectively enhanced.

Forming, in the antenna pattern, the protruding part to be embedded in the base body can enhance holding force of the antenna pattern to the base body. In particular, forming the protruding part in the antenna part of the antenna pattern can effectively prevent separation or the like of the antenna part from the base body, which is preferred from the viewpoint of being able to exhibit the desired antenna characteristics with stability.

The chip antenna having the above-mentioned structure can have a through hole that is formed from a front surface of the top wall to a rear surface thereof at a location immediately below the antenna part of the antenna pattern, and has an inner wall surface formed using a mold of the base body. This means that the base body is injection molded with the antenna part of the antenna pattern being appropriately arranged on a surface side of the top wall. Therefore, shape accuracy of the top wall (base body), and further, position accuracy of the antenna part with respect to the top wall can be enhanced. Thus, the desired antenna characteristics can be exhibited.

In order to further enhance the adhesion between the antenna pattern and the base body, it is preferred that the conductive plate forming the antenna pattern have a surface roughness Ra at least at a joining surface with the base body of 1.6 or more.

It is preferred that the resin molded for forming the base body have a high permittivity from the viewpoint of securing the desired antenna characteristics, and specifically, it is preferred that the resin have a permittivity of 4 or more. The resin having a permittivity of 4 or more is not necessarily limited to one in which a base resin has a permittivity of 4 or more, and comprises one in which the entire resin formulated with a filler has a permittivity of 4 or more.

### Advantageous Effects of Invention

As described above, according to the present invention, it is possible to provide the chip antenna at low cost that can prevent, to the largest extent possible, deformation of the base body accompanying mold shrinkage and temperature change and thus can exhibit desired antenna characteristics with stability.

### BRIEF DESCRIPTION OF DRAWINGS

FIG. 1 is a schematic perspective view of a circuit substrate having a chip antenna according to an embodiment of the present invention mounted on a surface thereof.

FIG. 2 is a plan view (top view) of the chip antenna illustrated in FIG. 1 seen from the direction A.

FIG. 3 is a plan view (left side view) of the chip antenna illustrated in FIG. 1 seen from the direction B.

FIG. 4 is a plan view (right side view) of the chip antenna illustrated in FIG. 1 seen from the direction C.

FIG. 5 is a plan view (bottom view) of the chip antenna illustrated in FIG. 1 seen from the direction D.

FIG. 6 is a sectional view of the chip antenna, and is an arrow sectional view taken along the line E-E of FIG. 2.

FIG. 7 is a sectional view of the chip antenna, and is an arrow sectional view taken along the line F-F of FIG. 2.

FIG. 8 is a sectional view of the chip antenna, and is an arrow sectional view taken along the line G-G of FIG. 2.

FIG. 9 is an explanatory view of processes for manufacturing the chip antenna illustrated in FIG. 1 to FIG. 6.

FIG. 10A is a schematic illustration of a state in which a mold for injection molding a base body of the chip antenna is swaged.

FIG. 10B is a schematic illustration of a state in which a resin is injected into the mold for injection molding the base body of the chip antenna.

### DESCRIPTION OF EMBODIMENT

Now, description is made of an embodiment of the present invention with reference to the drawings.

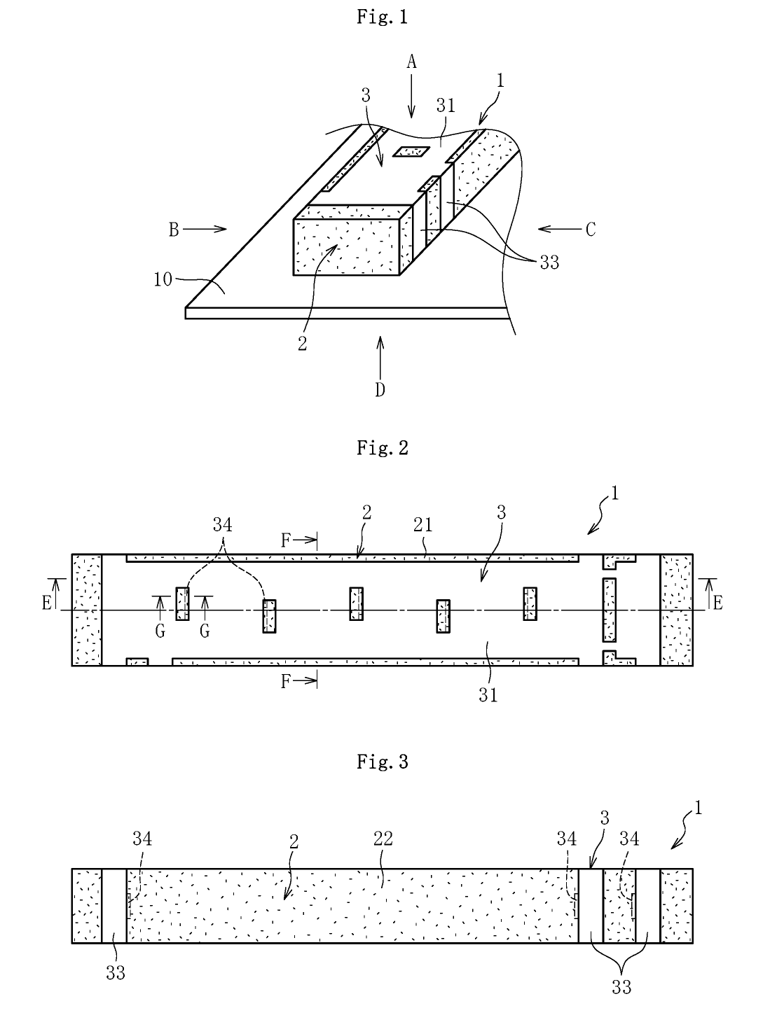

FIG. 1 is a schematic perspective view of a circuit substrate 10 having a chip antenna 1 according to an embodiment of the present invention mounted on a surface thereof. The chip antenna 1 illustrated in FIG. 1 comprises an antenna pattern 3 formed of a conductive plate and a base body 2 formed through injection molding a resin with the antenna pattern 3 serving as an insert component. An entire length dimension of the chip antenna 1 (dimension in a side-to-side direction in the plane of FIG. 2) depends on the frequency (wavelength) of radio waves transmitted/received by the chip antenna 1, and is, for example, on the order of from 10 mm to 50 mm. In the description below, for the sake of conveniently designating directions, an upward direction, a downward direction, a leftward direction, and a rightward direction in the plane of FIG. 1 are referred to as “up”, “down”, “left”, and “right”, respectively, but these do not limit the use of mode of the chip antenna 1.

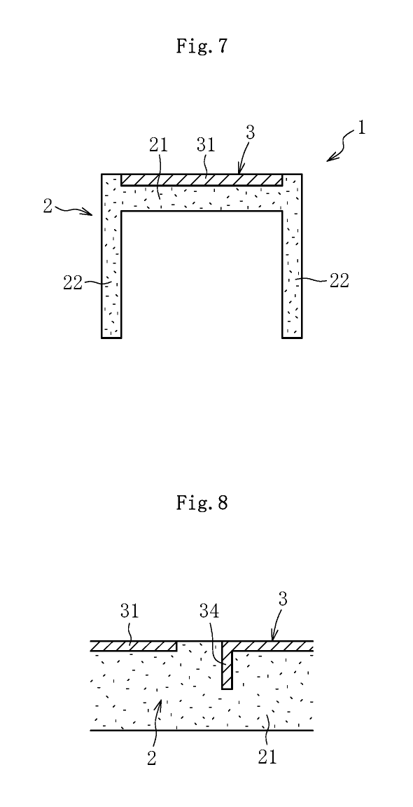

The antenna pattern 3 is formed through bending a conductive plate into a three-dimensional shape, and, as illustrated in FIG. 2 to FIG. 7, comprises, in an integral manner, an antenna part 31 configured to transmit/receive radio waves, a plurality of (in this embodiment, seven) terminal parts 32, and a plurality of connecting parts 33 configured to connect the antenna part 31 to the terminal parts 32. In reality, the connecting parts 33 also transmit/receive radio waves, but the amount of radio waves transmitted/received by the connecting parts 33 is negligibly small compared to the amount of radio waves transmitted/received by the antenna part 31. An example of the conductive plate is a metal plate such as a copper plate, a steel plate, or a SUS plate, or a plated metal plate thereof, which has a thickness set so as to be as small as possible insofar as the desired three-dimensional shape can be maintained (for example, 1 mm or less, and more preferably 0.5 mm or less). In order to enhance the adhesion between the antenna pattern 3 and the base body 2, the antenna pattern 3 (conductive plate) has a surface roughness Ra at a joining surface with the base body 2 set to be 1.6 or more, preferably 3.2 or more.

At least one of the plurality of (seven) terminal parts of the antenna pattern 3 functions as a feeding terminal electrically connected to a feeder of the circuit substrate 10, and at least one of the remaining terminal parts 32 functions as a ground terminal configured to ground the antenna pattern 3 via the circuit substrate 10. Further, the terminal parts 32 other than those that function as the feeding terminal and as the ground terminal function as fixing parts configured to fix the chip antenna 1 to the circuit substrate 10.

As described above, the base body 2 is formed through injection molding a resin with the antenna pattern 3 serving as an insert component. As the resin for forming the base body 2, one having a permittivity of 4 or more is selected and used. For example, one kind or two or more kinds of thermoplastic resins selected from the group consisting of polyphenylene sulfide (PPS), liquid crystal polymers (LCPs), polyamides (PAs), and the like as a base resin formulated with a filler such as ceramic can be used.

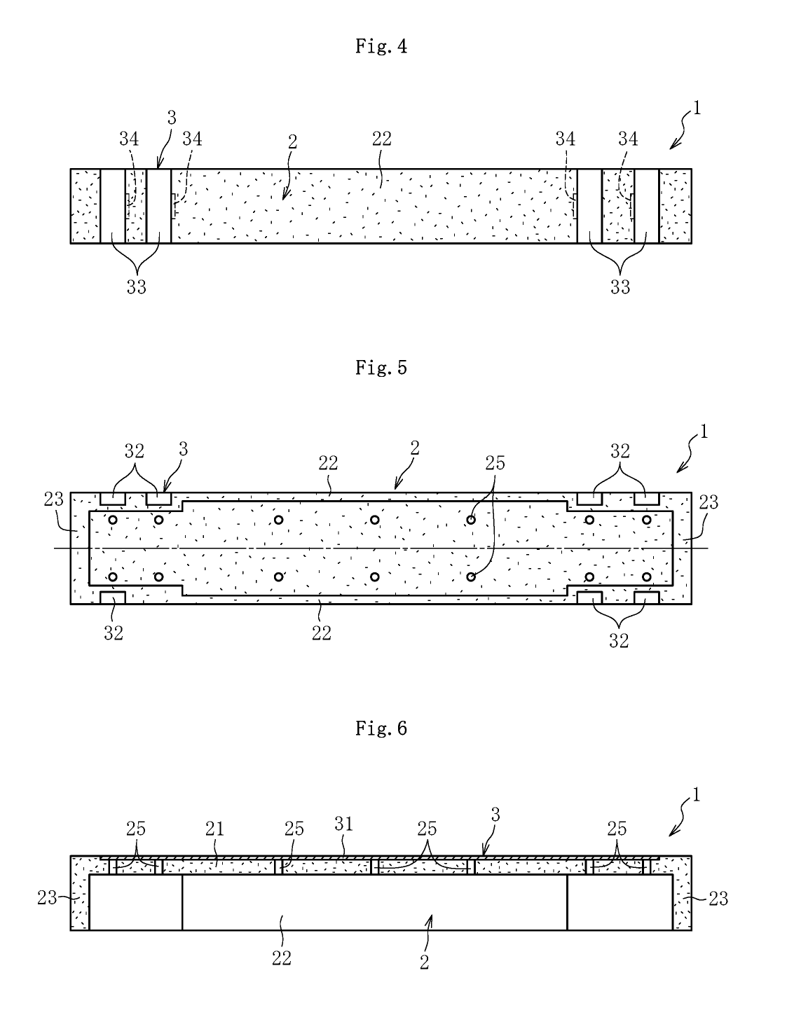

The base body 2 comprises a rectangular plate-like top wall 21 configured to hold the antenna part 31 of the antenna pattern 3 on a surface (upper surface) thereof, and rectangular plate-like vertical walls 22 and 22 provided upright along two long sides of the top wall 21 with one ends thereof in a short-side direction (upper ends) being connected to the top wall 21 and with another ends thereof in the short-side direction (lower end surfaces) holding the terminal parts 32 of the antenna pattern 3, respectively. The base body 2 according to this embodiment further comprises end walls 23 and 23 provided upright at both end parts of the top wall 21 in the long-side direction. In other words, the base body 2 according to this embodiment has a concave shape (reverse concave shape) in section at respective parts in the long-side direction thereof except for the both end parts in the long-side direction thereof. Thicknesses of the top wall 21, the pair of vertical walls 22, and the pair of end walls 23 and 23 are set to be approximately the same in a range of, for example, from 0.5 mm to 2.0 mm. As illustrated in FIG. 3 and FIG. 4, among the seven connecting parts 33 of the antenna pattern 3, three connecting parts 33 are held on a surface of the left vertical wall 22 (left side surface), while four connecting parts 33 are held on a surface of the right vertical wall 22 (right side surface). Therefore, among the seven terminal parts 32 of the antenna pattern 3, three terminal parts 32 are held on a lower end surface of the left vertical wall 22, and four terminal parts 32 are held on a lower end surface of the right vertical wall 22 (see FIG. 5).

The antenna pattern 3 comprises protruding parts 34 embedded in the base body 2. According to this embodiment, as illustrated in FIG. 2 to FIG. 4, five protruding parts 34 are formed in the antenna part 31, and one protruding part 34 is formed in each of the connecting parts 33. This can enhance the holding force of the antenna pattern 3 to the base body 2. In particular, formation of the protruding parts 34 in the antenna part 31 can effectively prevent the antenna part 31 from being separated from (floating up from) the base body 2 (top wall 21), which is advantageous in exhibiting desired antenna characteristics with stability.

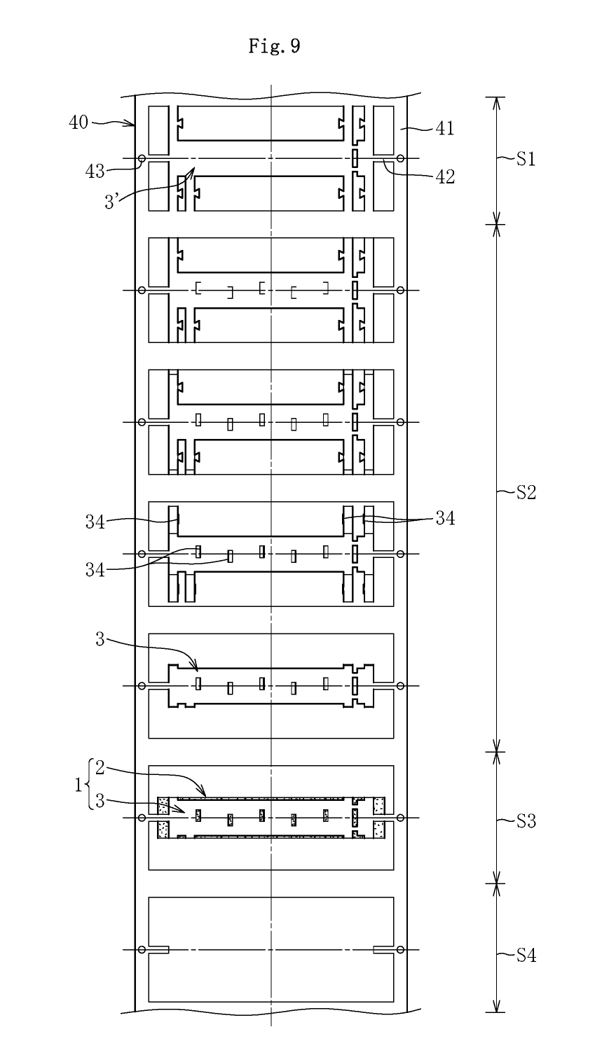

The protruding parts 34 formed in the antenna part 31 are formed through bending tongue-like parts, which are formed through forming slits piercing through both surfaces of the antenna part 31 (more specifically, a part to be the antenna part 31 of a developed pattern 3′ formed in a hoop material 40 as the conductive plate, see FIG. 9), to a rear surface side with proximal ends thereof being fulcra (see FIG. 8). According to this embodiment, the slits are formed so as to be U-shaped, but the slits may be formed into other shapes such as a semicircle. Further, according to this embodiment, as illustrated in FIG. 8, the protruding parts 34 are formed through bending the tongue-like parts described above to the rear surface side so as to form an angle of 90°, but the angle of the bent tongue-like parts can be set arbitrarily. On the other hand, the protruding part 34 formed in each of the connecting parts 33 is formed through bending a tongue-like part, which is formed through punching in the hoop material 40 (developed pattern 3′) serving as the conductive plate (see FIG. 9).

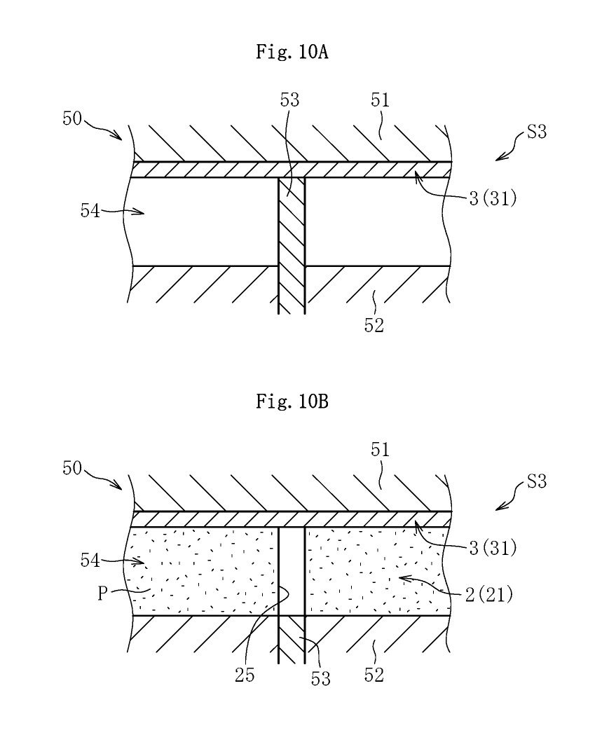

As illustrated in FIG. 5 and FIG. 6, the top wall 21 forming the base body 2 has a plurality of through holes 25 piercing through both surfaces of the top wall 21. Each of the through holes 25 pierces through both surfaces of the top wall 21 at locations immediately below the antenna part 31, and has an inner wall surface being a molded surface molded with a mold 50 (see FIG. 10) of the base body 2.

Next, a method of manufacturing the chip antenna 1 having the structure described above is described with reference to FIG. 9 and FIG. 10. Briefly, the chip antenna 1 according to this embodiment is manufactured through feeding the long conductive plate (hoop material 40) sequentially to a first step S1 of forming the developed pattern 3′, a second step S2 of forming the antenna pattern 3, a third step S3 of injection molding the base body 2, and a fourth step S4 of taking out the chip antenna 1. According to this embodiment, the second step S2 is performed in a plurality of stages (four stages).

In the first step S1, through punching part of the hoop material 40 with a stamping die (not shown), the developed pattern 3′ that is the antenna pattern 3 in the three-dimensional shape developed on a plane is formed. The developed pattern 3′ is coupled to a frame 41 of the hoop material 40 via bridges 42. A reference symbol 43 in FIG. 9 denotes alignment holes in the hoop material 40 with respect to a conveying apparatus (not shown).

When the developed pattern 3′ is formed, the hoop material 40 is conveyed downward in FIG. 9, and a part of the hoop material 40 in which the developed pattern 3′ is formed is fed sequentially to the first to fourth stages in the second step S2. In the first stage of the second step S2, slits are formed in a part of the developed pattern 3′ to be the antenna part 31 of the antenna pattern 3. After that, in the second to fourth stages, bending processing of the developed pattern 3′ is sequentially performed. This forms, in the hoop material 40, the antenna pattern 3 in the three-dimensional shape including the antenna part 31, the terminal parts 32, and the connecting parts 33 in an integral manner, with the protruding parts 34 being formed in the antenna part 31 and the connecting parts 33. The antenna pattern 3 formed in the hoop material 40 is coupled to the frame 41 via the bridges 42. The slit formation processing performed in the first stage of the second step S2 uses, for example, a punch press mold. The bending processing performed in each of the second to fourth stages of the second step S2 uses a bending press mold, or an actuator such as an air cylinder or a hydraulic cylinder.

Then, the hoop material 40 is conveyed further on a downstream side, and the part in which the antenna pattern 3 is formed is fed to the third step S3. In the third step S3, first, as illustrated in FIG. 10A, an upper mold 51 and a lower mold 52 of a mold 50 are moved so as to be relatively closer to each other (the mold 50 is swaged), and the antenna pattern 3 serving as an insert component is arranged in a cavity 54 defined between the upper mold 51 and the lower mold 52. A plurality of pins 53 that are vertically movable with respect to the lower mold 52 are arranged in a part of the mold 50 for forming the top wall 21 of the base body 2. When the antenna pattern 3 is arranged in the cavity 54 as the insert component, the pins 53 move upward so that an upper surface of the antenna part 31 of the antenna pattern 3 may be pressed against a lower surface of the upper mold 51 (the antenna part 31 may be sandwiched between and fixed by the upper mold 51 and the pins 53). In this state, a resin P (PPS, an LCP, a PA or the like as a base resin formulated with a filler such as ceramic) in a molten state is injected and filled into the cavity 54, and the base body 2 is molded so as to be integral with the antenna pattern 3 (see FIG. 10B). After the resin P is solidified, the mold 50 is opened to obtain the chip antenna 1 coupled to the frame 41 of the hoop material 40 via the bridges 42. The pins 53 may be formed integrally with the lower mold 52. In this case, as the mold 50 is swaged, the antenna part 31 of the antenna pattern 3 is sandwiched between and fixed by the upper mold 51 and the pins 53.

The base body 2 is formed through injection molding the resin integrally with the antenna pattern 3 coupled to the frame 41 of the hoop material 40 to obtain the chip antenna 1 comprising the base body 2 and the antenna pattern 3. Then, the chip antenna 1 coupled to the frame 41 of the hoop material 40 is fed to the fourth step S4. This separates the molded product (chip antenna 1) from the frame 41 of the hoop material 40.

The fourth step S4 for separating the chip antenna 1 from the hoop material 40 is not necessarily required to be sequentially provided to the third step S3 on a downstream side thereof. Specifically, instead of the fourth step S4 for separating the chip antenna 1 from the hoop material 40, a winding step may be provided on the downstream side of the third step S3. The winding step comprises winding the hoop material 40 in which (the antenna pattern 3 of) the chip antenna 1 is left coupled to the frame 41 via the bridges 42 in a roll. Winding the hoop material 40 without separating the chip antenna 1 from the frame 41 in this way makes storage and conveyance of the hoop material 40 easier. Further, the aligned state of the chip antenna 1 can be maintained, and thus, contact (interference) among the chip antennas 1 can be prevented.

As described above, in the chip antenna 1 according to the present invention, when the base body 2 comprises the rectangular plate-like top wall 21 and the rectangular plate-like vertical walls 22 provided upright along the long-side direction of the top wall 21 with one ends thereof in the short-side direction (upper ends) being connected to the top wall 21, not only are the respective parts of the base body 2 able to be thinned (into a thin plate) to reduce the amount of sink marks (recesses) that occur accompanying mold shrinkage, but also the rigidity (flexural rigidity) of the top wall 21 can be enhanced to prevent warpage, a crook, or the like of the base body 2 in the direction along the long side of the top wall 21 to the largest extent possible. Therefore, the antenna part 3 of the antenna pattern 1 can be held on the surface of the base body 2 (top wall 21) with stability, and the desired antenna characteristics can be exhibited. Further, according to the structure described above, the amount of usage of the resin can be reduced to reduce the cost. In particular, the base body 2 according to this embodiment exhibits a concave shape (reverse concave shape) in section, with the vertical walls 22 being provided upright along the two long sides of the top wall 21, and thus, the rigidity of the chip antenna 1 can be effectively enhanced.

Further, the protruding parts 34 to be embedded in the base body 2 are formed in the antenna pattern 3, and thus, holding force of the antenna pattern 3 to the base body 2 can be enhanced. In particular, the protruding parts 34 are formed in the antenna part 31 of the antenna pattern 3, and thus, separation or the like of the antenna part 31 from the base body 2 (part of the antenna part 31 floating up from the base body 2) can be effectively prevented.

Further, the base body 2 forming the chip antenna 1 has the through holes 25 that pierce through both surfaces of the top wall 21 at locations immediately below the antenna part 31 of the antenna pattern 3, and have inner wall surfaces formed using the mold 50 of the base body 2. This means that the base body 2 is injection molded under a state in which the antenna part 31 of the antenna pattern 3 is appropriately located on a surface side of the top wall 21. Therefore, shape accuracy of the top wall 21 (base body 2), and further, position accuracy of the antenna part 31 with respect to the top wall 21 can be enhanced, and thus, the desired antenna characteristics can be exhibited.

An embodiment of the present invention is described above, but the present invention is not limitedly applied to the embodiment described above. Specifically, the chip antenna 1 according to the present invention can adopt an arbitrary shape insofar as the base body 2 can be formed through injection molding a resin with the antenna pattern 3 in a three-dimensional shape serving as the insert component. For example, although not illustrated, the base body 2 may be formed of the rectangular plate-like top wall 21 holding the antenna part 31 on a surface (upper surface) thereof and the rectangular plate-like vertical wall 22 provided upright along a long side of the top wall 21 so that a section orthogonal to the long-side direction is L-shaped (reverse L-shaped). Also in this case, the end walls 23 may be formed at both end parts of the top wall 21 in the long-side direction.

Further, the shape of the antenna pattern 3 described above is only exemplary, and may be changed as appropriate depending on the required antenna characteristics or the like.

### REFERENCE SIGNS LIST

1 chip antenna

2 base body

3 antenna pattern

10 circuit substrate

21 top wall

22 vertical wall

23 end wall

25 through hole

31 antenna part

32 terminal part

33 connecting part

34 protruding part

40 hoop material (conductive plate)

50 mold

54 pin

S1 first step

S2 second step

S3 third step

S4 fourth step

1. A chip antenna, comprising:
an antenna pattern formed through bending a conductive plate into a three-dimensional shape, the antenna pattern comprising an antenna part and a terminal part electrically connected to a circuit substrate; and
a base body formed through injection molding a resin with the antenna pattern serving as an insert component,
wherein the base body comprises:
a rectangular plate-like top wall holding the antenna part on a surface thereof; and
a rectangular plate-like vertical wall provided upright along a long-side direction of the top wall with one end thereof in a short-side direction being connected to the top wall and with another end thereof in the short-side direction holding the terminal part.

2. The chip antenna according to claim 1, wherein the vertical wall comprises vertical walls provided along two long sides, respectively, of the top wall.

3. The chip antenna according to claim 1, wherein the antenna pattern has a protruding part embedded in the base body.

4. The chip antenna according to claim 3, wherein the protruding part is formed in the antenna part.

5. The chip antenna according to claim 1, wherein the chip antenna has a through hole that is formed from a front surface of the top wall to a rear surface thereof at a location immediately below the antenna part, and has an inner wall surface formed using a mold of the base body.

6. The chip antenna according to claim 1, wherein a part of the antenna pattern at least at a joining surface with the base body has a surface roughness Ra of 1.6 or more.

7. The chip antenna according to claim 1, wherein the base body is formed through injection molding a resin having a permittivity of 4 or more.
